(19) United States
(12) Patent Application Publication
(10) Pub. No.: US 2025/0099990 A1
(43) Pub. Date: Mar. 27, 2025

(54) NOZZLES FOR ENTRAINMENT DRIVEN FLOWS

(71) Applicants: Spar Systems Inc., Montvale, NJ (US); UT-Battelle, LLC, Oak Ridge, TN (US)

(72) Inventors: Gaurav Bazaz, Montvale, NJ (US); Nithin S. Panicker, Knoxville, TN (US); Prashant K. Jain, Knoxville, TN (US)

(73) Assignees: Spar Systems Inc., Montvale, NJ (US); UT-Battelle, LLC, Oak Ridge, TN (US)

(21) Appl. No.: 18/371,993

(22) Filed: Sep. 22, 2023

(51) Int. Cl. B05B 7/08; B05B 1/34; B05B 7/06

(52) U.S. Cl. CPC B05B 7/0815; B05B 1/34; B05B 7/066

(57) ABSTRACT

The present disclosure involves designs for a fluid channel assembly that allow for a high entrainment ratio while also sustaining a high fluid mass flow rate through the assembly. The fluid channel assembly includes a first fluid passage and a second fluid passage, where the first and second fluid passages are arranged such that fluid from the second fluid passage is entrained in fluid from the first fluid passage. Fluid passes through at least a portion of the first fluid passage in a form of a plurality of first fluid streams.

The United States Government has rights in this invention pursuant to contract no. DE-AC05-00OR22725 between the United States Department of Energy and UT-Battelle, LLC.

### TECHNICAL FIELD

The present disclosure generally relates to designs for fluid channel assemblies. More specifically, the disclosure relates to improved fluid channel assemblies configured to allow for high entrainment ratios.

### BACKGROUND

Entrainment is a process in which a fluid in motion mobilizes another fluid through one or more physical mechanisms such as pressure differentials, turbulence, and shear stress. Entrainment allows for the efficient mobilization of fluids and the mixing of fluids. Entrainment is used in various fluid mechanisms such as eductor-jet pumps, pump-jets, and ventilator masks.

A nozzle accelerates a fluid passing through it. The fluid is input to the nozzle and accelerated fluid is output from the nozzle. The nozzle accelerates the fluid by reducing the flow area that is available to the fluid, which in turn, due to the requirement of mass flow continuity, causes the flow velocity to increase. Nozzles are used in various entrainment driven systems such as ejector pumps. The nozzle accelerates one fluid, called the motive fluid, which in turn creates a negative pressure which entrains a secondary fluid, the entrainment fluid. Fluid passing through a nozzle can also undergo other changes in its characteristics, as it is accelerated by the nozzle. These include a drop in static pressure, a drop in density and a drop in temperature. Nozzles can thus convert the potential energy of the fluid, embodied in its static pressure and temperature, into kinetic energy, embodied in its flow velocity. Nozzles are often categorized into one of 3 types: (a) convergent nozzles, (b) divergent nozzles, and (c) convergent-divergent nozzles. Nozzles are used in many applications, including for example in rocket engines, irrigation, painting, mixing, spraying of fluids, and many others.

Nozzles play an important role in many fluid devices. For entrainment driven devices, nozzles help create the conditions to trigger entrainment.

### SUMMARY

The following presents a simplified summary of various aspects of this disclosure in order to provide a basic understanding of such aspects. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

Conventional nozzles used in fluid channel assemblies are designed to accelerate a motive fluid to a target flow velocity. However, in fluid channel assemblies having a nozzle used to entrain a fluid, there has been little design innovation to maximize the amount of a motive fluid jet ejected from the nozzle that engages in entrainment. As a result, conventional nozzles are limited in their ability to mobilize entrainment fluid. For instance, conventional ejector pumps incorporating conventional nozzles usually achieve entrainment ratios of 1 to 2 or less.

The nozzle design innovations provided in this disclosure enable mechanisms for achieving a much higher level of entrainment than conventional nozzles allow. Optimization of an entrainment ratio (or a ratio of a mass flow rate of an entrainment fluid to a mass flow rate of a motive fluid) is of interest for achieving a higher level of entrainment. It has been observed that, in order to maximize the entrainment ratio of a fluid channel assembly having a fluid entrainment function, one important factor is the maximization of the portion of a motive fluid flow ejected from a nozzle that can engage in entrainment activity. In this case, a fluid channel assembly having a fluid entrainment function relates to a fluid channel assembly in which one or more nozzles are used to deliver the motive fluid and generate one or more low-pressure regions that entrain an entrainment fluid (or a fluid to be entrained). By maximizing the surface area of the motive fluid flow emanating from the nozzle to the volume flow rate of the same flow, one can increase the portion of the motive fluid flow engaging in entrainment activity, in turn increasing the flow rate of the entrained flow relative to the flow rate of the motive fluid and therefore the entrainment ratio.

The disclosed innovations can have wide applications in various engineering systems, including advanced ejector pump systems, fluid mixing systems, and ventilation systems. Additionally, the disclosed innovations can also be utilized for mobilizing air in direct-air carbon capture systems by replacing or augmenting fan-based systems.

Generally, the proposed fluid channel assembly concepts can help achieve a much higher fluid mass flow rate through a fluid channel assembly while allowing for a high entrainment rate, resulting in a higher efficiency fluid mobilization mechanism.

In one aspect of the present disclosure, a fluid channel assembly configured to achieve a high entrainment ratio is described. The fluid channel assembly includes a first fluid passage comprising a first fluid inlet and a first fluid outlet, wherein the first fluid passage is configured to receive the first fluid at the first fluid inlet, and wherein the first fluid passage is configured to channel the first fluid through the first fluid outlet. The fluid channel assembly also includes a second fluid passage comprising a second fluid inlet and a second fluid outlet, wherein the second fluid passage is configured to receive a second fluid at the second fluid inlet, and where the second fluid passage is configured to channel the second fluid through the second fluid outlet. The first fluid passage and the second fluid passage interface such that the second fluid is entrained in the first fluid through a formation of a low-pressure region in the first fluid. The first fluid passage is configured such that the first fluid passes through at least a portion of the first fluid passage in a form of a plurality of first fluid streams.

In some configurations of this aspect, the first fluid passage is contained at least partially within the second fluid passage, or the first fluid passage is entirely contained within the second fluid passage.

In some configurations of this aspect, the first fluid passage is configured such that the plurality of first fluid streams is channeled through a corresponding plurality of first nozzle structure apertures to form the plurality of first fluid streams. The plurality of first nozzle structure apertures can be arranged along a single plane, along a two-dimensional matrix, or in a form of folded plane configuration. One of the plurality of first nozzle structure apertures can be separated by another of the plurality of first nozzle structure apertures by a nozzle structure aperture gap.

In another aspect of the present disclosure, a fluid channel assembly configured to achieve a high entrainment ratio is described. The fluid channel assembly includes a first fluid passage comprising a first fluid inlet and a first fluid outlet, wherein the first fluid passage is configured to receive the first fluid at the first fluid inlet, and wherein the first fluid passage is configured to channel the first fluid through the first fluid outlet. The fluid channel assembly also includes a second fluid passage comprising a second fluid inlet and a second fluid outlet, wherein the second fluid passage is configured to receive a second fluid at the second fluid inlet, and where the second fluid passage is configured to channel the second fluid through the second fluid outlet. The first fluid passage and the second fluid passage interface such that the second fluid is entrained in the first fluid through a formation of a low-pressure region in the first fluid. Along a plane perpendicular to the second fluid outlet, a cross-sectional area of the second fluid passage is greater than or equal to 25 times a cross-sectional area of the first fluid passage.

In some configurations of this aspect, the first fluid passage is contained at least partially within the second fluid passage, or the first fluid passage is entirely contained within the second fluid passage.

In some configurations of this aspect, the first fluid passage comprises a plurality of first nozzle structure apertures and the plurality of first nozzle structure apertures is arranged along a single plane.

In some configurations of this aspect, the first fluid passage comprises a plurality of first nozzle structure apertures and the plurality of first nozzle structure apertures is arranged along a two-dimensional matrix.

In some configurations of this aspect, the first fluid passage comprises a plurality of first nozzle structure apertures and the plurality of first nozzle structure apertures is arranged in a form of folded plane configuration.

In another aspect of the present disclosure, a fluid channel assembly configured to achieve a high entrainment ratio is described. The fluid channel assembly includes a first fluid passage comprising a first fluid inlet and a first fluid outlet, wherein the first fluid passage is configured to receive the first fluid at the first fluid inlet, and wherein the first fluid passage is configured to channel the first fluid through the first fluid outlet. The fluid channel assembly also includes a second fluid passage comprising a second fluid inlet and a second fluid outlet, wherein the second fluid passage is configured to receive a second fluid at the second fluid inlet, and where the second fluid passage is configured to channel the second fluid through the second fluid outlet. The first fluid passage and the second fluid passage interface such that the second fluid is entrained in the first fluid through a formation of a low-pressure region in the first fluid. The first fluid passage and the second fluid passage are arranged such that, under operational conditions, a ratio of a mass flow rate of the second fluid in the fluid channel assembly to a mass flow rate of a first fluid in the fluid channel assembly of greater than or equal to 25 is achieved.

In some configurations of this aspect, the first fluid passage is configured such that a plurality of the first fluid streams is channeled through the first fluid outlet to form a plurality of first fluid streams.

In some configurations of this aspect, the first fluid passage is contained at least partially within the second fluid passage, or the first fluid passage is entirely contained within the second fluid passage.

In some configurations of this aspect, the first fluid passage comprises a plurality of first nozzle structure apertures and the plurality of first nozzle structure apertures is arranged along a single plane.

In some configurations of this aspect, the first fluid passage comprises a plurality of first nozzle structure apertures and the plurality of first nozzle structure apertures is arranged along a two-dimensional matrix.

In some configurations of this aspect, the first fluid passage comprises a plurality of first nozzle structure apertures and the plurality of first nozzle structure apertures is arranged in the form of folded plane configuration.

### BRIEF DESCRIPTION OF THE DRAWINGS

The present disclosure is illustrated by way of example, and not by way of limitation, in the figures of the accompanying drawings.

FIG. 1A provides a side view of a fluid channel assembly including a first fluid passage having a single circular nozzle structure configured to channel motive fluid and including a second fluid passage configured to channel fluid to be entrained.

FIG. 1B provides a front view of a fluid channel assembly including a first fluid passage having a single circular nozzle structure configured to channel motive fluid and including a second fluid passage configured to channel fluid to be entrained.

FIG. 2A provides a side view of a fluid channel assembly including a first fluid passage having a single elongate nozzle structure configured to channel motive fluid and including a second fluid passage configured to channel fluid to be entrained.

FIG. 2B provides a front view of a fluid channel assembly including a first fluid passage having a single elongate nozzle structure configured to channel motive fluid and including a second fluid passage configured to channel fluid to be entrained.

FIG. 3A provides a side view of a fluid channel assembly including a first fluid passage having plurality of nozzle structure apertures to channel motive fluid, where the plurality of nozzle structure apertures is arranged along a single plane, and including a second fluid passage configured to channel fluid to be entrained.

FIG. 3B provides a front view of a fluid channel assembly including a first fluid passage having plurality of nozzle structure apertures to channel motive fluid, where the plurality of nozzle structure apertures is arranged along a single plane (shown arranged along a plane that is perpendicular to the page on which FIG. 3B lies, or, along a plane orthogonal to the plane of viewing) and including a second fluid passage configured to channel fluid to be entrained.

FIG. 4A provides a side view of a fluid channel assembly including a first fluid passage having plurality of nozzle structure apertures to channel motive fluid, where the plurality of nozzle structure apertures is arranged along a two-dimensional matrix, and including a second fluid passage configured to channel fluid to be entrained.

FIG. 4B provides a front view of a fluid channel assembly including a first fluid passage having plurality of nozzle structure apertures to channel motive fluid, where the plurality of nozzle structure apertures is arranged along a two-dimensional matrix (shown arranged along a plane that is perpendicular to the page on which FIG. 4B lies, or, along a plane orthogonal to the plane of viewing), and including a second fluid passage configured to channel fluid to be entrained.

FIG. 5A provides a side view of a fluid channel assembly including a first fluid passage having plurality of nozzle structure apertures to channel motive fluid, where the plurality of nozzle structure apertures is arranged in the form of a folded plane configuration, and including a second fluid passage configured to channel fluid to be entrained.

FIG. 5B provides a front view of a fluid channel assembly including a first fluid passage having plurality of nozzle structure apertures to channel motive fluid, where the plurality of nozzle structure apertures is arranged in the form of a folded plane configuration (shown arranged along a plane that is perpendicular to the page on which FIG. 5B lies, or, along a plane orthogonal to the plane of viewing), and including a second fluid passage configured to channel fluid to be entrained.

### DETAILED DESCRIPTION

Before the present subject matter is described in detail, it is to be understood that this disclosure is not limited to the particular implementations described, as such may vary. It should also be understood that the terminology used herein is for describing particular implementations only, and is not intended to be limiting, since the scope of the present disclosure will be limited only by the appended claims. While this disclosure is susceptible to different implementations in different forms, there is shown in the drawings and will here be described in detail a preferred implementation of the disclosure with the understanding that the present disclosure is to be considered as an exemplification of the principles of the disclosure and is not intended to limit the broad aspect of the disclosure to the implementation illustrated. All features, elements, components, functions, and steps described with respect to any implementation provided herein are intended to be freely combinable and substitutable with those from any other implementation unless otherwise stated. Therefore, it should be understood that what is illustrated is set forth only for the purposes of example and should not be taken as a limitation on the scope of the present disclosure.

In the following description and in the figures, like elements are identified with like reference numerals. The use of “e.g.,” “etc.,”, “or” and “the like” indicates non-exclusive alternatives without limitation, unless otherwise noted. The use of “having”, “comprising”, “including” or “includes” means “including, but not limited to,” or “includes, but not limited to,” unless otherwise noted.

Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one implementation, to A only (optionally including entities other than B); in another implementation, to B only (optionally including entities other than A); in yet another implementation, to both A and B (optionally including other entities). These entities may refer to elements, actions, structures, steps, operations, values, and the like.

The glossary below provides definitions for terms used in this application:

Total pressure: This is the sum of the static pressure and dynamic pressure of a fluid.

Static pressure: The pressure applied by a fluid on its container walls, that is not the consequence of the translational motion of the fluid.

Dynamic pressure: The pressure applied by a fluid due to its translational motion.

Total energy (of a fluid): The total energy of a fluid is the sum of the pressure energy, the kinetic energy, and the potential energy.

Conversion of static and dynamic pressure: Static pressure can be converted to dynamic pressure and vice versa, such that total energy of the fluid is conserved.

Terrestrial atmosphere: Terrestrial atmosphere refers to the atmosphere of Earth, composed mainly of air.

Subsonic and Supersonic: When a fluid is moving slower than the velocity of sound in the fluid under the given physical conditions (temperature, density, pressure), it is considered subsonic flow. When the fluid is moving faster than the velocity of sound in the fluid under the given physical conditions (temperature, density, pressure), it is considered supersonic flow.

Compressible flow and laws of compressible flow: When a fluid during its motion undergoes changes in density, and the changes in density are sufficiently large that they cannot be ignored in the analysis of the fluid flow, the flow is considered compressible. The physical laws that describe such a flow are the laws of compressible flow. This is distinct from incompressible flow, wherein the density variations are trivial enough that they can be ignored in the analysis of the fluid. Compressible and incompressible flow are well understood terms of art in the field. When a fluid undergoes compressible flow, conversion of thermal energy to kinetic energy can be significant.

Flow channels: This refers to physical structures that constrain the flow of a fluid.

Mass flow rate: The mass of the fluid that travels through a given space or region over a fixed time. It's usually measured in kilograms per second.

Fluid mobilization device: This refers to devices such as axial fans, centrifugal fans, compressors, and other similar turbomachines that place stationary fluids in motion through rotational motion of the device.

Entrainment duct: This refers to a fluid passage through which a fluid to be entrained passes. The fluid to be entrained is entrained through interaction with a low-pressure region generated by the movement of a motive fluid through a motive fluid passage that interfaces with the entrainment duct.

Motive fluid: This refers to a fluid that flows through a motive fluid passage. Movement of the motive fluid flow through the motive fluid passage generates a low-pressure region that entrains a fluid to be entrained, which passes through an entrainment duct.

While the apparatus and method described here apply to most Newtonian fluids, the description mostly uses atmospheric air as the exemplar fluid. Nevertheless, the disclosure here applies to other Newtonian fluids such as water as well, and not just atmospheric air.

Various aspects of the above referenced system are described in detail herein by way of examples, rather than by way of limitation.

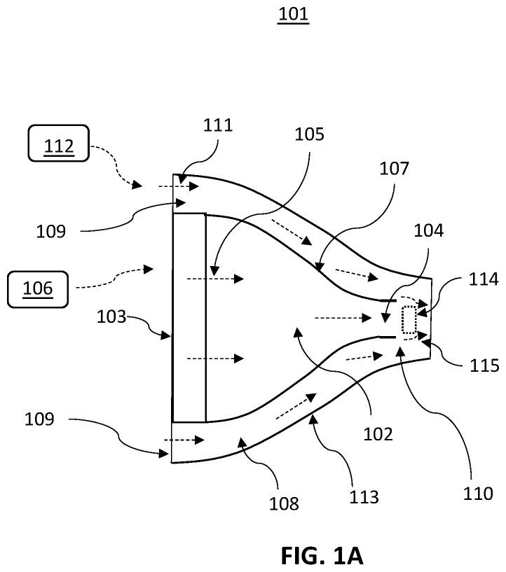

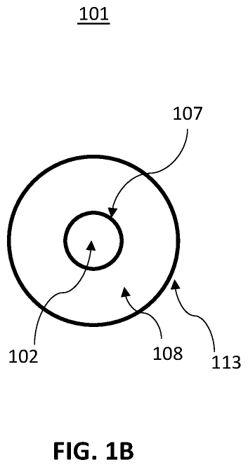

FIGS. 1A and 1B illustratively depict side and front views of a fluid channel assembly 101, respectively. As shown, the fluid channel assembly 101 includes a first fluid passage 102 having a first fluid inlet 103 and a first fluid outlet 104. The first fluid passage 102 is configured to receive a first fluid 105 at the first fluid inlet 103 and channel the first fluid 105 through the first fluid outlet 104. The first fluid passage 102 may be a motive fluid passage configured to receive a motive fluid at the first fluid inlet 103 and channel the motive fluid through the first fluid outlet 104.

The first fluid 105 enters the first fluid inlet 103 from a first fluid source 106. The first fluid source 106 may include, for example, a fluid mobilization device, which can include, but is not limited to, an axial fan configured to propel a fluid (e.g., a motive fluid) through the first fluid inlet 103. In other configurations, the fluid mobilization device can include a centrifugal fan or a pressurized fluid container with an adjustable valve structure operable to discharge a first fluid 105 towards or through the first fluid inlet 103.

The first fluid 105 may include a substance that includes particles that deform or flow under applied shear stresses or external forces. The substance can include, for example but without limitation, gases, such as air, steam, oxygen, carbon monoxide, carbon dioxide, nitrogen, or liquids, such as water, oil, and alcohol. In some configurations, the first fluid 105 may include both a gas and a liquid, including but not limited to mists or aerosols.

The fluid channel assembly 101 includes a first fluid passage wall 107 that at least in part contains the first fluid passage 102. The first fluid passage wall 107 extends from the first fluid inlet 103 to the first fluid outlet 104. The first fluid passage wall 107 as shown is present in the form of a nozzle structure and includes a converging section such that a relatively wide portion of the nozzle structure is present at the first fluid inlet 103 and such that a relatively narrow portion of the nozzle structure is present at the first fluid outlet 104. In other configurations, the nozzle structure can alternatively or additionally include a diverging section or a converging-diverging section.

The fluid channel assembly 101 includes a second fluid passage 108 having a second fluid inlet 109 and a second fluid outlet 110. The second fluid passage 108 is configured to receive a second fluid 111 at the second fluid inlet 109 and channel the second fluid 111 through the second fluid outlet 110. The second fluid passage 108 may be an entrainment fluid passage configured to receive a fluid to be entrained at the second fluid inlet 109 and channel the fluid to be entrained through the second fluid outlet 110. The second fluid passage 108 may also be referred to as an entrainment duct.

The second fluid 111 enters the second fluid inlet 109 from a second fluid source 112. The second fluid source 112 may include, for example, a fluid present in an environment proximal to the second fluid outlet 110, such as ambient or atmospheric air. In other configurations, the second fluid source 112 may include, for example, a fluid mobilization device, which can include, but is not limited to, an axial fan configured to propel a fluid (e.g., a fluid to be entrained) through the second fluid inlet 109. In other configurations, the fluid mobilization device can include a centrifugal fan or a pressurized fluid container with an adjustable valve structure operable to discharge a second fluid 111 towards or through the second fluid inlet 109.

In some configurations, the second fluid 111 in the second fluid source 112 can be stationary, or can depart or be ejected from the second fluid source 112 at a lower velocity than that the velocity at which the first fluid 105 departs from or is ejected from the first fluid source 106. In some configurations, the second fluid 111 can enter the second fluid inlet 109 at a lower velocity than the velocity at which the first fluid 105 enters the first fluid inlet 103.

The second fluid 111 may include a substance that includes particles that deform or flow under applied shear stresses or external forces. The substance can include, for example but without limitation, gases, such as air, steam, oxygen, carbon monoxide, carbon dioxide, nitrogen, or liquids, such as water, oil, and alcohol. In some configurations, the second fluid 111 may include both a gas and a liquid, including but not limited to mists or aerosols.

The fluid channel assembly 101 includes a second fluid passage wall 113 that at least in part contains the second fluid passage 108. The second fluid passage wall 113 extends from the second fluid inlet 109 to the second fluid outlet 110. The second fluid passage wall 113 as shown is present in the form of an annular structure that surrounds the first fluid passage wall 107. The second fluid passage wall 113 as shown includes a converging section such that a relatively wide portion of the second fluid passage wall 113 is present at the second fluid inlet 109 and such that a relatively narrow portion of the second fluid passage wall 113 is present at the second fluid outlet 110. In other configurations, the second fluid passage wall 113 can alternatively or additionally include a diverging section or a converging-diverging section.

As shown, the shape or geometry of the second fluid passage wall 113 is aligned with the shape or geometry of the first fluid passage wall 107. For example, the second fluid passage wall 113 as shown includes a converging section along the length of the second fluid passage wall 113 that is aligned with a converging section along the length of the first fluid passage wall 107. However, in other configurations, the shape or geometry of the second fluid passage wall 113 may be different from the shape or geometry of the first fluid passage wall 107. For example, but without limitation, the second fluid passage wall 113 may have the same width along the entire length of the second fluid passage wall 113, or the second fluid passage wall 113 may vary in width along the length of the second fluid passage wall 113 in a manner that is not aligned with the variation in width of the first fluid passage wall 107 along the length of the first fluid passage wall 107.

The first fluid passage 102 and the second fluid passage 108 interface such that the second fluid 111 is entrained in the first fluid 105 through a formation of a low-pressure region 114 in the first fluid 105. The first fluid passage wall 107 is configured such that the first fluid 105 passing therethrough increases in velocity as it moves from the first fluid inlet 103 to the first fluid outlet 104. Following from Bernoulli's principle, a relatively low-pressure region 114 is established in the first fluid 105 emitted from the first fluid outlet 104. In other words, the increase in velocity of the first fluid 105 causes a formation of a low-pressure region 114 in the first fluid 105. The low-pressure region 114 in turn causes a mass of the second fluid 111 to be drawn towards and become entrained in the first fluid 105, thereby forming an entrained second fluid stream 115 within the first fluid 105.

Other configurations are possible. For example, although as shown, the second fluid passage 108 fully surrounds the first fluid passage 102, in other configurations, the second fluid passage 108 may only surround a portion of the first fluid passage 102. In still other configurations, the first fluid passage 102 can partially or fully surround the second fluid passage 108. In still other configurations, the first fluid passage 102 and the second fluid passage 108 can be arranged such that neither fluid passage surrounds the other. Additionally, although as shown, the second fluid outlet 110 extends beyond the first fluid outlet 104, in other configurations, the second fluid outlet 110 can terminate at the same distance along the length of the fluid channel assembly 101 as the first fluid outlet 104, or the first fluid outlet 104 can extend beyond the second fluid outlet 110.

The illustrated fluid channel assembly 101 is configured to allow for a high entrainment ratio, or ratio of a mass flow rate of the second fluid 111 in the fluid channel assembly 101 to the mass flow rate of the first fluid 105 in the fluid channel assembly 101. It has been realized that a high entrainment ratio can be achieved by optimizing the portion of the first fluid 105 that can engage in fluid entrainment activity with the second fluid 111. In some configurations, the optimization of the portion of the first fluid 105 that can engage in fluid entrainment activity with the second fluid 111 can be achieved at least in part by optimizing the cross-sectional area of the second fluid passage 108 relative to the cross-sectional area of the first fluid passage 102 along a plane perpendicular to the second fluid outlet 110, or along a plane perpendicular to an average direction of fluid flow at an area at which the first fluid passage 102 and the second fluid passage 108 interface. In some configurations, a cross-sectional area of the second fluid passage 108 can be greater than or equal to 25 times a cross-sectional area of the first fluid passage 102 along a plane perpendicular to the second fluid outlet 110. In other configurations, a cross-sectional area of the second fluid passage 108 can be greater than or equal to 25 times a cross-sectional area of the first fluid passage 102 along a plane perpendicular to an average direction of fluid flow at an area at which the first fluid passage 102 and the second fluid passage 108 interface. In some configurations, under operational conditions, or when one or more fluids are passing through the first fluid passage 102 and the second fluid passage 108, an entrainment ratio, or a ratio of a mass flow rate of the second fluid 111 in the fluid channel assembly 101 to the mass flow rate of the first fluid 105 in the fluid channel assembly 101, of greater than or equal to 50 can be achieved. In other configurations, an entrainment ratio of 25-100 or 50-100 can be achieved. In still other configurations, an entrainment ratio of greater than or equal to 100 can be achieved. In order to achieve this, the following examples are provided. In one implementation, the nozzle structure aperture minimum diameter may be set to 0.1 mm. In another implementation, the constraint may be set to keep approximately the same entrainment ratio, but the mass flow rate may be increased, and more nozzle structure apertures may be added, and the entrainment duct cross-sectional area may be increased to keep area ratios of the nozzle structure apertures and entrainment duct the same. In yet another implementation, the diameter of the nozzle structure aperture may also be a constraint on the mass flow rate of the fluid but not on the entrainment ratio.

Referring again to FIGS. 1A and 1B, it has also been realized that a central portion of the flow of the first fluid 105 may have relatively less exposure to the flow of the second fluid 111 than an outer portion of the first fluid 105 (e.g. a portion of the first fluid 105 that is more proximal to the first fluid passage wall 107, or to the second fluid 111 at or proximal to the first fluid outlet 104), reducing the ability of the central portion of the flow of the first fluid 105 to engage in entrainment activity with the second fluid 111 and thereby reducing the achievable entrainment ratio. Referring again to FIGS. 1A and 1B, in one implementation, the portion of the first fluid 105 that engages in entrainment activity with the second fluid 111, or entrains the second fluid 111, is optimized through configuration of the first fluid passage wall 107 such that the first fluid 105 passes through a nozzle structure with a small width at the first fluid outlet 104 relative to the second fluid passage 108 with which it interfaces or engages. In operation, when the first fluid 105 passing through the small-width nozzle structure is channeled through the first fluid outlet 104, a relatively greater portion of the first fluid 105 can engage in entrainment activity with the second fluid 111 than if a nozzle structure with a larger width at the first fluid outlet 104 relative to the second fluid passage 108 with which it interfaces or engaged is used.

Although FIGS. 1A and 1B illustrates a configuration of the first fluid passage wall 107 in which the first fluid 105 is passed through a single circular nozzle structure having a small width at the first fluid outlet 104 relative to the second fluid passage 108 with which it interfaces or engages, for some applications, a greater mass flow rate of first fluid 105 through the first fluid outlet 104 than that which can be achieved with such a small width nozzle structure is desirable. In some configurations, it is desirable to control or optimize both the entrainment ratio and mass flow rate through the first fluid outlet 104. In some configurations, it is desirable to both maximize the entrainment ratio and the mass flow rate through the first fluid outlet 104 that can be achieved.

The terms “first fluid” and “second fluid” used in the description may alternatively be referred to as “motive fluid” and “entrainment fluid,” respectively.

The arrows that are connected to dashed-line trails represent the direction of fluid flow. However, in some configurations, fluid may flow in different direction(s) than depicted. Fluid generally flows in the illustrated directions in bulk; however, in some configurations, local variations in flow fluid that deviate from the bulk flow may be observed. Moreover, fluid sources (e.g., 106, 112, 206, 212, 306, 312, 406, 412, 506, and 512 are each represented by a box in the figures. However, these boxes may be any shape, size, or any fluid source and the boxes are provided for exemplary purposes only and do not define the size and/or shape of the sources.

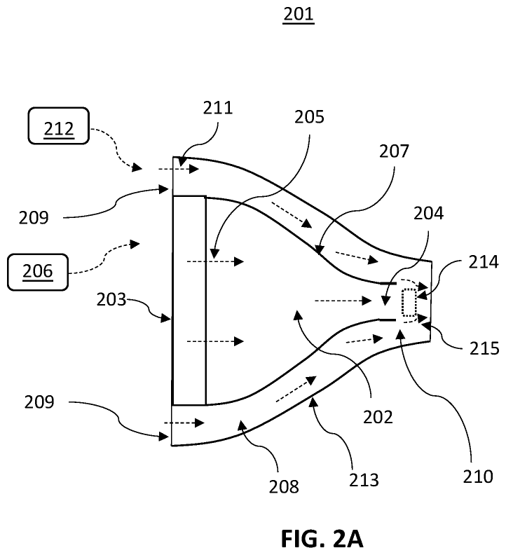

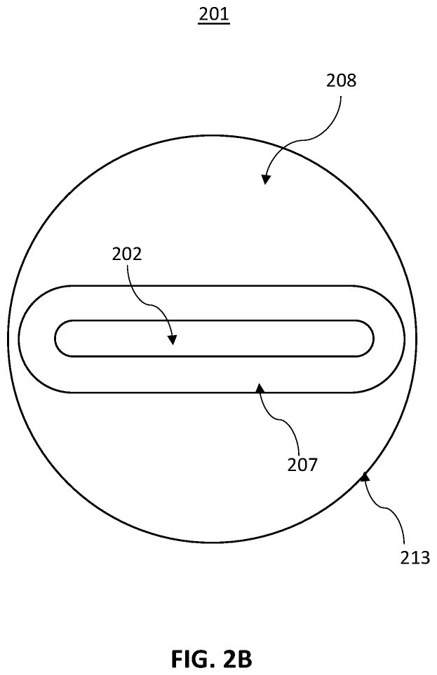

FIGS. 2A and 2B illustratively depict side and front views of an alternative fluid channel assembly 201, respectively. The fluid channel assembly 201 as shown is analogous in some respects to the fluid channel assembly 101 depicted and described with respect to FIGS. 1A and 1B. As depicted, the fluid channel assembly 201 includes a first fluid passage 202 having a first fluid inlet 203 and a first fluid outlet 204. The fluid channel assembly 201 further includes a first fluid passage wall 207 that at least in part contains the first fluid passage 202. The fluid channel assembly 201 also includes a second fluid passage 208 having a second fluid inlet 209 and a second fluid outlet 210. The second fluid passage 208 may also be referred to as an entrainment duct. The fluid channel assembly 201 further includes a second fluid passage wall 213 that at least in part contains the second fluid passage 208. The second fluid passage wall 213 extends from the second fluid inlet 209 to the second fluid outlet 210.

The first fluid passage 202 and the second fluid passage 208 interface such that the second fluid 211 is entrained in the first fluid 205 through the formation of a low-pressure region 214 in the first fluid 205. The first fluid passage wall 207 is configured such that a first fluid 205 passing therethrough increases in velocity as it moves from the first fluid inlet 203 to the first fluid outlet 204. Following from Bernoulli's principle, a relatively low-pressure region 214 is established in the first fluid 205 emitted from the first fluid outlet 204. In other words, the increase in velocity of the first fluid 205 causes a formation of a low-pressure region 214 in the first fluid 205. The low-pressure region 214 in turn causes a mass of a second fluid 211 to be drawn towards and become entrained in the first fluid 205, thereby forming an entrained second fluid stream 215 within the first fluid 205.

However, differing from the fluid channel assembly 101 depicted and described with respect to FIGS. 1A and 1B, instead of the first fluid passing through a single circular nozzle structure having a small width at the first fluid outlet 104 relative to the second fluid passage 108, the fluid channel assembly 201 depicted in FIGS. 2A and 2B includes a first fluid passage wall 207 configured such that the first fluid 205 is passed through an elongate nozzle structure having a relatively wider width where it engages with the second fluid passage 208. The elongate nozzle can allow for a first fluid 205 (for example, a motive fluid) to be propelled out from the first fluid outlet 204 in a thin sheet-like profile, allowing for a relatively higher mass flow rate from the first fluid outlet 204 while also allowing for a high proportion of the first fluid 205 propelled out from the first fluid outlet 204 to engage in entrainment activity with the second fluid 211.

Although the nozzle structure depicted in the figures may be circular, the nozzle structure may be a different shape (or multiple nozzle structures may differ in shape from one another). In some implementations, the elongate nozzle structure can have, but is not limited to, a rectangle-like, rounded rectangle-like, oval-like, or ellipse-like cross-section.

As described above, some features in FIGS. 2A and 2B are similar to those in FIGS. 1A and 1B. Therefore, the description of some features in FIGS. 1A and 1B also applies to similar features in FIGS. 2A and 2B. In FIG. 2A, the first fluid 205 enters the first fluid inlet 203 from a first fluid source 206. Additionally, the second fluid 211 enters the second fluid inlet 209 from a second fluid source 212. These features are similar to those described above with respect to FIG. 1A and therefore, the description of FIG. 1A applies equally to FIG. 2A.

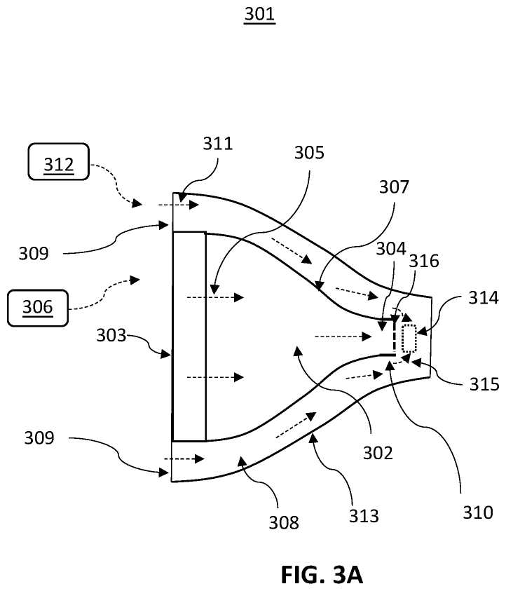

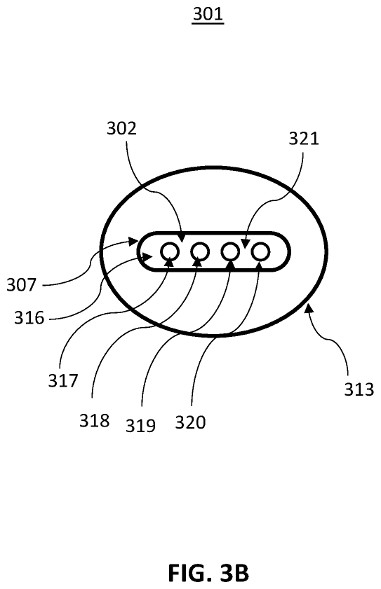

Still other approaches are contemplated for controlling or optimizing both entrainment ratio and mass flow rate. FIGS. 3A and 3B illustratively depict side and front views of an alternative fluid channel assembly 301, respectively. The fluid channel assembly 301 as shown is analogous in some respects to the fluid channel assembly 101 depicted and described with respect to FIGS. 1A and 1B. As depicted, the fluid channel assembly 301 includes a first fluid passage 302 having a first fluid inlet 303 and a first fluid outlet 304. The fluid channel assembly 301 further includes a first fluid passage wall 307 that at least in part contains the first fluid passage 302. The fluid channel assembly 301 also includes a second fluid passage 308 having a second fluid inlet 309 and a second fluid outlet 310. The second fluid passage 308 may also be referred to as an entrainment duct. The fluid channel assembly 301 further includes a second fluid passage wall 313 that at least in part contains the second fluid passage 308. The second fluid passage wall 313 extends from the second fluid inlet 309 to the second fluid outlet 310.

The first fluid passage 302 and the second fluid passage 308 interface such that the second fluid 311 is entrained in the first fluid 305 through the formation of a low-pressure region 314 in the first fluid 305. The first fluid passage wall 307 is configured such that a first fluid 305 passing therethrough increases in velocity as it moves from the first fluid inlet 303 to the first fluid outlet 304. Following from Bernoulli's principle, a relatively low-pressure region 314 is established in the first fluid 305 emitted from the first fluid outlet 304. In other words, the increase in velocity of the first fluid 305 causes a formation of a low-pressure region 314 in the first fluid 305. The low-pressure region 314 in turn causes a mass of a second fluid 311 to be drawn towards and become entrained in the first fluid 305, thereby forming an entrained second fluid stream 315 within the first fluid 305.

As described above, some features in FIGS. 3A and 3B are similar to those in FIGS. 1A and 1B. Therefore, the description of some features in FIGS. 1A and 1B also apply to similar features in FIGS. 3A and 3B. In FIG. 3A, the first fluid 305 enters the first fluid inlet 303 from a first fluid source 306. Additionally, the second fluid 311 enters the second fluid inlet 309 from a second fluid source 312. These features are similar to those described above with respect to FIG. 1A and therefore, the description of FIG. 1A applies equally to FIG. 3A.

However, differing from the fluid channel assembly 101 depicted and described with respect to FIGS. 1A and 1B, instead of the first fluid passing through a single circular nozzle structure having a small width at the first fluid outlet 104 relative to the second fluid passage 108, the fluid channel assembly 301 depicted in FIGS. 3A and 3B includes a first fluid passage 302 configured such that the first fluid 305 is passed through at least a portion of the first fluid passage 302 in the form of a plurality of first fluid streams. In the illustrated implementation, the plurality of first fluid streams is arranged along a single plane. As illustrated in FIG. 3B, the plurality of first fluid streams is arranged along a plane that is perpendicular to the page on which FIG. 3B lies, or, along a plane orthogonal to the plane of viewing. In other configurations, the plurality of first fluid streams may be arranged along one or more planes that are perpendicular to the page on which FIG. 3B lies, or along one or more planes orthogonal to the plane of viewing.

As shown in FIGS. 3A and 3B, a nozzle structure element 316 is present in the first fluid passage 302 at or in a location proximal to the first fluid outlet 304, or upstream of the first fluid outlet 304. In some configurations, the nozzle structure element 316 form a part of the first fluid passage 302, or may be integral with the first fluid passage wall 307. In other configurations, the nozzle structure element 316 may be a separate element that can be fitted inside, secured, or otherwise be present in the first fluid passage 302.

The nozzle structure element 316 includes a plurality of nozzle structure apertures. The plurality of nozzle structure apertures is arranged along a single plane. The plurality of nozzle structure apertures can include a first nozzle structure aperture 317, a second nozzle structure aperture 318, a third nozzle structure aperture 319, and a fourth nozzle structure aperture 320. However, it should be understood that the nozzle structure element 316 may have fewer than four nozzle structure apertures. For example, the nozzle structure element 316 may have two or three nozzle structure apertures. In other configurations, the nozzle structure element 316 may have greater than four nozzle structure apertures. As illustrated in FIG. 3B, the plurality of nozzle structure apertures is arranged along a plane that is perpendicular to the page on which FIG. 3B lies, or, along a plane orthogonal to the plane of viewing. In some configurations, the plurality of nozzle structure apertures may be arranged along one or more planes that are perpendicular to the page on which FIG. 3B lies, or along one or more planes orthogonal to the plane of viewing.

The first fluid passage 302 may be configured such that the plurality of first fluid streams is formed by channeling the first fluid 305 through a corresponding plurality of nozzle structure apertures, which may allow for a plurality of low-pressure regions 314 to be generated. Advantageously, the first fluid 305 in each first fluid stream in the plurality of first fluid streams can engage in entrainment activity with the second fluid 311 at or proximal to the first fluid outlet 304 or otherwise where the first fluid streams interface or engage with the second fluid passage 308, potentially allowing for increased entrainment ratio and mass flow rate.

In order to further promote entrainment of the second fluid 311 in the low-pressure regions 314 generated by channeling the first fluid 305 through the corresponding plurality of nozzle structure apertures, in some configurations, fluid streams in the plurality of first fluid streams may be physically isolated. In some configurations, for example, one of the plurality of nozzle structure apertures may be separated by another of the plurality of nozzle structure apertures by a nozzle structure aperture gap 321. The length of the nozzle structure aperture gap 321 may be selected in such a way that the entrainment ratio and the mass flow rate are optimized. If the length of the nozzle structure aperture gap 321 is too small, the mass flow rate of the first fluid 305 in a given space or volume of the first fluid passage 302 may be heightened, but the entrainment ratio may be excessively lessened. If the length of the nozzle structure aperture gap 321 is too large, the entrainment ratio may be heightened, but the mass flow rate of the first fluid 305 in a given space or volume of the first fluid passage 302 may be excessively lessened. In order to achieve a desired balance between an optimized entrainment ratio and mass flow rate of the first fluid 305, in some configurations, the nozzle structure aperture gap 321 may be, for example, be greater than or equal to the diameter of an adjacent nozzle structure aperture.

In some configurations, adjacent nozzle structure apertures of the plurality of nozzle structure apertures may be separated from one another by one or more nozzle structure aperture gaps 321. In some configurations, each nozzle structure aperture of the plurality of nozzle structure apertures may be separated from other nozzle structure apertures of the plurality of nozzle structure apertures by one or more nozzle structure aperture gaps 321.

In an implementation, the placement of multiple nozzle structure apertures in a single plane adjacent to one another may result in beneficial effects such as a large mass flow rate, which results in a large total fluid mass flow rate downstream of a nozzle structure aperture and fluid channel assembly, and a high ratio of fluid outlet surface area to second fluid passage, which enables stronger entrainment compared to having a single large fluid outlet. Therefore, multiple nozzle structure apertures (or outlets) allow for higher mass flow. Moreover, higher surface areas of nozzle structure apertures relative to the second fluid passage area allows higher entrainment ratio versus one for a single large nozzle structure aperture.

Although in FIGS. 3A and 3B, a nozzle structure element 316 is used to establish a plurality of first fluid streams, other mechanisms for establishing a plurality of first fluid streams may be contemplated. For example, in some configurations, the first fluid passage wall 307 may be structured such that it is sub-divided into a plurality of first fluid sub-passages that form a plurality of nozzle structures with nozzle structure apertures through which a plurality of first fluid streams is formed. In some configurations, instead of a single first fluid passage, multiple first fluid passages comprising nozzle structures with nozzle structure apertures can be used to channel a plurality of first fluid streams toward a plurality of first fluid outlets such that the first fluid streams can entrain one or more second fluids from one or more second fluid passages.

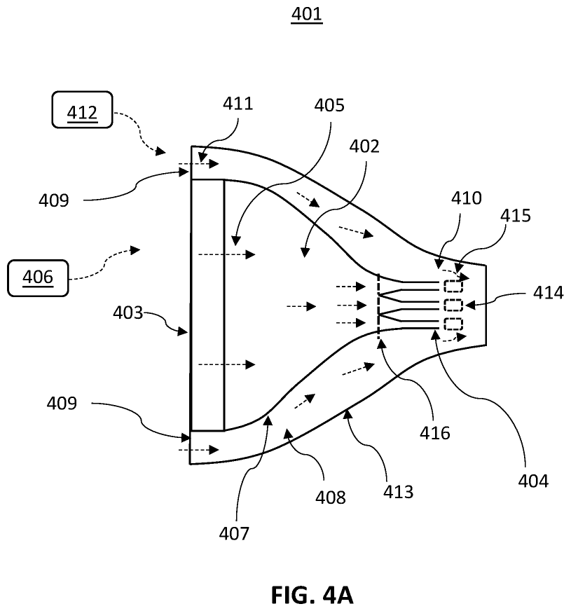

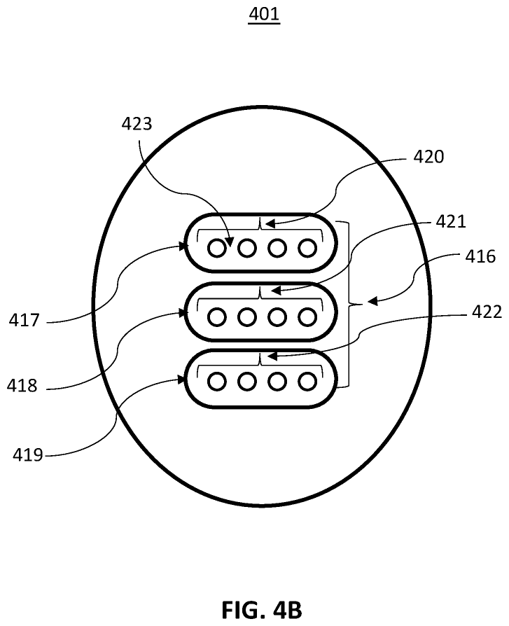

FIGS. 4A and 4B illustratively depict side and front views of an alternative fluid channel assembly 401, respectively. The fluid channel assembly 401 as shown is analogous in some respects to the fluid channel assembly 301 depicted and described with respect to FIGS. 3A and 3B. As depicted, the fluid channel assembly 401 includes a first fluid passage 402 having a first fluid inlet 403 and a first fluid outlet 404. The fluid channel assembly 401 further includes a first fluid passage wall 407 that at least in part contains the first fluid passage 402. The fluid channel assembly 401 also includes a second fluid passage 408 having a second fluid inlet 409 and a second fluid outlet 410. The second fluid passage 408 may also be referred to as an entrainment duct. The fluid channel assembly 401 further includes a second fluid passage wall 413 that at least in part contains the second fluid passage 408. The second fluid passage wall 413 extends from the second fluid inlet 409 to the second fluid outlet 410.

The first fluid passage 402 and the second fluid passage 408 interface such that the second fluid 411 is entrained in the first fluid 405 through the formation of a low-pressure region 414 in the first fluid 405. The first fluid passage wall 407 is configured such that a first fluid 405 passing therethrough increases in velocity as it moves from the first fluid inlet 403 to the first fluid outlet 404. Following from Bernoulli's principle, a relatively low-pressure region 414 is established in the first fluid 405 emitted from the first fluid outlet 404. In other words, the increase in velocity of the first fluid 405 causes a formation of a low-pressure region 414 in the first fluid 405. The low-pressure region 414 in turn causes a mass of a second fluid 411 to be drawn towards and become entrained in the first fluid 405, thereby forming an entrained second fluid stream 415 within the first fluid 405.

As described above, some features in FIGS. 4A and 4B are similar to those in FIGS. 3A and 3B. Therefore, the description of some features in FIGS. 3A and 3B also apply to similar features in FIGS. 4A and 4B. In FIG. 4A, the first fluid 405 enters the first fluid inlet 403 from a first fluid source 406. Additionally, the second fluid 411 enters the second fluid inlet 409 from a second fluid source 412. These features are similar to those described above with respect to FIG. 3A and therefore, the description of FIG. 3A applies equally to FIG. 4A.

However, differing from the fluid channel assembly 301 depicted and described with FIGS. 3A and 3B, instead of the first fluid 305 passing through at least a portion of the first fluid passage 302 in the form of a plurality of first fluid streams arranged along a single plane, the fluid channel assembly 401 depicted in FIGS. 4A and 4B includes a first fluid passage 402 configured such that the first fluid 405 is passed through at least a portion of the first fluid passage 402 in the form of a plurality of first fluid streams arranged along multiple planes. In the illustrated implementation, the plurality of first fluid streams is arranged along a two-dimensional matrix. As illustrated in FIG. 4B, the plurality of first fluid streams is arranged along a plane that is perpendicular to the page on which FIG. 4B lies, or, along a plane orthogonal to the plane of viewing. In some configurations, the plurality of first fluid streams is arranged along one or more planes that are perpendicular to the page on which FIG. 4B lies, or along one or more planes orthogonal to the plane of viewing.

As shown in FIGS. 4A and 4B, a nozzle structure element assembly 416 is present in the first fluid passage 402 at or in a location proximal to or the first fluid outlet 404, or upstream of the first fluid outlet 404. In some configurations, the nozzle structure element assembly 416 may form a part of the first fluid passage 402, or may be integral with the first fluid passage wall 407. In other configurations, the nozzle structure element assembly 416 may include one or more separate elements that can be fitted inside, secured, or otherwise be present in the first fluid passage 402.

The nozzle structure element assembly 416 includes a plurality of nozzle structure elements arranged along a first axis. The plurality of nozzle structure elements can include a first nozzle structure element 417, a second nozzle structure element 418, and a third nozzle structure element 419. However, it should be understood that the nozzle structure assembly 416 may have fewer than three nozzle structure elements. For example, the nozzle structure element assembly 416 may have two nozzle structure elements 417. In other configurations, the nozzle structure element assembly 416 may have greater than three nozzle structure elements.

In the illustrated implementation, the first, second, and third nozzle structure elements 417, 418, and 419 include first, second, and third pluralities of nozzle structure apertures 420, 421, 422. Each of the pluralities of nozzle structure apertures 420, 421, 422 is arranged along a second axis, and include first, second, third, and fourth nozzle structure apertures. However, it should be understood that one or more of the plurality of nozzle structure elements may have fewer than four nozzle structure apertures. For example, one or more of the plurality of nozzle structure elements may have two or three nozzle structure apertures. In other configurations, one or more of the plurality of nozzle structure elements may have greater than four nozzle structure apertures.

The nozzle structure element assembly 416 and the pluralities of nozzle structure apertures are arranged such that a two-dimensional matrix of nozzle structure apertures is formed, and such that a first fluid 405 passing therethrough is converted to a plurality of first fluid streams arranged along a two-dimensional matrix. As illustrated in FIG. 4B, the pluralities of nozzle structure apertures that form the matrix are arranged along a plane that is perpendicular to the page on which FIG. 4B lies, or, along a plane orthogonal to the plane of viewing. In some configurations, the pluralities of nozzle structure apertures that form the matrix may be arranged along one or more planes that are perpendicular to the page on which FIG. 4B lies, or along one or more planes orthogonal to the plane of viewing. In the illustrated implementation, the two-dimensional matrices are in the form of a three-by-four matrix of nozzle structure apertures or first fluid streams. However, other x-by-y matrices of nozzle structure apertures or first fluid streams may be contemplated.

The first fluid passage 402 may be configured such that the plurality of first fluid streams is formed by channeling the first fluid 405 through a corresponding plurality of nozzle structure apertures in the nozzle structure element assembly 416, which may allow for a plurality of low-pressure regions 414 to be generated. Advantageously, the first fluid 405 in each first fluid stream in the plurality of first fluid streams can engage in entrainment activity with the second fluid 411 at the first fluid outlet 404 or otherwise where the first fluid streams interface or engage with the second fluid passage 408, potentially allowing for increased entrainment ratio and mass flow rate.

In order to further promote entrainment of the second fluid 411 in the low-pressure regions 414 generated by channeling the first fluid 405 through the corresponding plurality of nozzle structure apertures in the nozzle structure element assembly 416, in some configurations, fluid streams in the plurality of first fluid streams may be physically isolated. In some configurations, for example, one of the plurality of nozzle structure apertures may be separated by another of the plurality of nozzle structure apertures in the same nozzle structure element or in a different nozzle structure element by a nozzle structure aperture gap 423. The length of the nozzle structure aperture gap 423 may be selected in such a way that the entrainment ratio and the mass flow rate are optimized. If the length of the nozzle structure aperture gap 423 is too small, the mass flow rate of the first fluid 405 in a given space or volume of the first fluid passage 402 may be heightened, but the entrainment ratio may be excessively lessened. If the length of the nozzle structure aperture gap 423 is too large, the entrainment ratio may be heightened, but the mass flow rate of the first fluid 405 in a given space or volume of the first fluid passage 402 may be excessively lessened. In order to achieve a desired balance between an optimized entrainment ratio and mass flow rate of the first fluid 405, in some configurations, the nozzle structure aperture gap 423 may be, for example, be greater than or equal to the diameter of an adjacent nozzle structure aperture.

In some configurations, adjacent nozzle structure apertures of the plurality of nozzle structure apertures in the same nozzle structure element or in a different nozzle structure element may be separated from one another by one or more nozzle structure aperture gaps 423. In some configurations, each nozzle structure aperture of the plurality of nozzle structure apertures may be separated from other nozzle structure apertures of the plurality of nozzle structure apertures in the same nozzle structure element or in one or more different nozzle structure elements by one or more nozzle structure aperture gaps 423. The nozzle structure aperture gaps 423 may all be the same dimensions (length, width, height), or may differ from one another.

Although in FIGS. 4A and 4B, a nozzle structure element assembly 416 is used to establish a plurality of first fluid streams, other mechanisms for establishing a plurality of first fluid streams may be contemplated. For example, in some configurations, the first fluid passage wall 407 may be structured such that it is sub-divided into a plurality of first fluid sub-passages along multiple planes that form a plurality of nozzle structures with nozzle structure apertures through which a plurality of first fluid streams is formed. In some configurations, instead of a single first fluid passage, multiple first fluid passages comprising nozzle structures with nozzle structure apertures along multiple planes can be used to channel a plurality of first fluid streams toward a plurality of first fluid outlets such that the first fluid streams can entrain one or more second fluids from one or more second fluid passages.

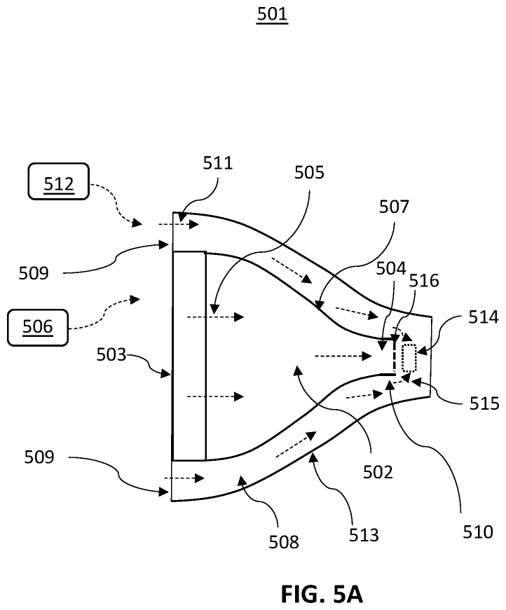

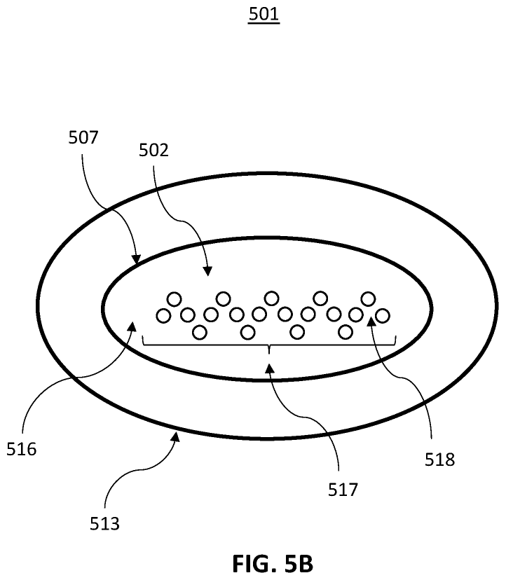

FIGS. 5A and 5B illustratively depict side and front views of an alternative fluid channel assembly 501, respectively. The fluid channel assembly 501 as shown is analogous in some respects to the fluid channel assembly 301 depicted and described with respect to FIGS. 3A and 3B. As depicted, the fluid channel assembly 501 includes a first fluid passage 502 having a first fluid inlet 503 and a first fluid outlet 504. The fluid channel assembly 501 further includes a first fluid passage wall 507 that at least in part contains the first fluid passage 502. The fluid channel assembly 501 also includes a second fluid passage 508 having a second fluid inlet 509 and a second fluid outlet 510. The second fluid passage 508 may also be referred to as an entrainment duct. The fluid channel assembly 501 further includes a second fluid passage wall 513 that at least in part contains the second fluid passage 508. The second fluid passage wall 513 extends from the second fluid inlet 509 to the second fluid outlet 510.

The first fluid passage 502 and the second fluid passage 508 interface such that the second fluid 511 is entrained in the first fluid 505 through the formation of a low-pressure region 514 in the first fluid 505. The first fluid passage wall 507 is configured such that a first fluid 505 passing therethrough increases in velocity as it moves from the first fluid inlet 503 to the first fluid outlet 504. Following from Bernoulli's principle, a relatively low-pressure region 514 is established in the first fluid 505 emitted from the first fluid outlet 504. In other words, the increase in velocity of the first fluid 505 causes a formation of a low-pressure region 514 in the first fluid 505. The low-pressure region 514 in turn causes a mass of a second fluid 511 to be drawn towards and become entrained in the first fluid 505, thereby forming an entrained second fluid stream 515 within the first fluid 505.

As described above, some features in FIGS. 5A and 5B are similar to those in FIGS. 3A and 3B. Therefore, the description of some features in FIGS. 3A and 3B also apply to similar features in FIGS. 5A and 5B. In FIG. 5A, the first fluid 505 enters the first fluid inlet 503 from a first fluid source 506. Additionally, the second fluid 511 enters the second fluid inlet 509 from a second fluid source 512. These features are similar to those described above with respect to FIG. 3A and therefore, the description of FIG. 3A applies equally to FIG. 5A.

However, differing from the fluid channel assembly 301 depicted and described with FIGS. 3A and 3B, instead of the first fluid 305 passing through at least a portion of the first fluid passage in the form of a plurality of first fluid streams arranged along a single plane, the fluid channel assembly 501 depicted in FIGS. 5A and 5B includes a first fluid passage 502 configured such that the first fluid 505 is passed through at least a portion of the first fluid passage 502 in the form of a plurality of first fluid streams arranged along multiple planes. In the illustrated implementation, the plurality of first fluid streams is arranged in a form of folded plane configuration. As illustrated in FIG. 5B, the plurality of first fluid streams in the folded plane configuration form is arranged along a plane that is perpendicular to the page on which FIG. 5B lies, or along a plane orthogonal to the plane of viewing. In some configurations, the plurality of first fluid streams in the folded plane configuration form is arranged along one or more planes that are perpendicular to the page on which FIG. 5B lies, or along one or more planes orthogonal to the plane of viewing.

As shown in FIGS. 5A and 5B, a nozzle structure element 516 is present in the first fluid passage 502 at or in a location proximal to the first fluid outlet 504, or upstream of the first fluid outlet 504. In some configurations, the nozzle structure element 516 may form a part of the first fluid passage 502, or may be integral with the first fluid passage wall 507. In other configurations, the nozzle structure element 516 may be a separate element that can be fitted inside, secured, or otherwise be present in the first fluid passage 502.

The nozzle structure element 516 includes a plurality of nozzle structure apertures 517. The plurality of nozzle structure apertures 517 is arranged along multiple planes, and the nozzle structure apertures 517 vary in position along a width of the nozzle structure element 516 in a form of folded plane configuration. As illustrated in FIG. 5B, the plurality of nozzle structure apertures in the folded plane configuration form is arranged along a plane that is perpendicular to the page on which FIG. 5B lies, or along a plane orthogonal to the plane of viewing. In some configurations, the plurality of nozzle structure apertures in the folded plane configuration form is arranged along one or more planes that are perpendicular to the page on which FIG. 5B lies, or along one or more planes orthogonal to the plane of viewing. As illustrated, the nozzle structure apertures 517 are arranged in a serpentine or zig-zag arrangement. Alternatively, the nozzle structure apertures 517 vary in position along a pair of axes perpendicular to the second fluid outlet 510, or along a plane perpendicular to an average direction of fluid flow at an area at which the first fluid passage 502 and the second fluid passage 508 interface.

The first fluid passage 502 may be configured such that the plurality of first fluid streams is formed by channeling the first fluid 505 through a corresponding plurality of nozzle structure apertures 517, which may allow for a plurality of low-pressure regions 514 to be generated. Advantageously, the first fluid 505 in each first fluid stream in the plurality of first fluid streams can engage in entrainment activity with the second fluid 511 at the first fluid outlet 504 or otherwise where the first fluid streams interface or engage with the second fluid passage 508, potentially allowing for increased entrainment ratio and mass flow rate.

In order to further promote entrainment of the second fluid 511 in the low-pressure regions 514 generated by channeling the first fluid 505 through the corresponding plurality of nozzle structure apertures 517, in some configurations, fluid streams in the plurality of first fluid streams may be physically isolated. In some configurations, for example, one of the plurality of nozzle structure apertures 517 may be separated by another of the plurality of nozzle structure apertures by a nozzle structure aperture gap 518. The length of the nozzle structure aperture gap 518 may be selected in such a way that the entrainment ratio and the mass flow rate are optimized. If the length of the nozzle structure aperture gap 518 is too small, the mass flow rate of the first fluid 505 in a given space or volume of the first fluid passage 502 may be heightened, but the entrainment ratio may be excessively lessened. If the length of the nozzle structure aperture gap 518 is too large, the entrainment ratio may be heightened, but the mass flow rate of the first fluid 505 in a given space or volume of the first fluid passage 502 may be excessively lessened. In order to achieve a desired balance between an optimized entrainment ratio and mass flow rate of the first fluid 505, in some configurations, the nozzle structure aperture gap 518 may be, for example, be greater than or equal to the diameter of an adjacent nozzle structure aperture.

In some configurations, adjacent nozzle structure apertures of the plurality of nozzle structure apertures may be separated from one another by one or more nozzle structure aperture gaps. In some configurations, each nozzle structure aperture of the plurality of nozzle structure apertures may be separated from other nozzle structure apertures of the plurality of nozzle structure apertures by one or more nozzle structure aperture gaps.

Although in FIGS. 5A and 5B, a nozzle structure element 516 is used to establish a plurality of first fluid streams, other mechanisms for establishing a plurality of first fluid streams may be contemplated. For example, in some configurations, the first fluid passage wall 507 may be structured such that it is sub-divided into a plurality of first fluid sub-passages that form a plurality of nozzle structures with nozzle structure apertures through which a plurality of first fluid streams is formed. In some configurations, instead of a single first fluid passage, multiple first fluid passages comprising nozzle structures with nozzle structure apertures can be used to channel a plurality of first fluid streams toward a plurality of first fluid outlets such that the first fluid streams can entrain one or more second fluids from one or more second fluid passages.

While the implementations are susceptible to various modifications and alternative forms, specific examples thereof have been shown in the drawings and are herein described in detail. It should be understood, however, that these implementations are not to be limited to the particular form disclosed, but to the contrary, these implementations are to cover all modifications, equivalents, and alternatives falling within the spirit of the disclosure. Furthermore, any features, functions, steps, or elements of the implementations may be recited in or added to the claims, as well as negative limitations that define the inventive scope of the claims by features, functions, steps, or elements that are not within that scope.

What is claimed is:

1. A fluid channel assembly comprising:
a first fluid passage comprising a first fluid inlet and a first fluid outlet, wherein the first fluid passage is configured to receive a first fluid at the first fluid inlet, and wherein the first fluid passage is configured to channel the first fluid through the first fluid outlet, and
a second fluid passage comprising a second fluid inlet and a second fluid outlet, wherein the second fluid passage is configured to receive a second fluid at the second fluid inlet, and wherein the second fluid passage is configured to channel the second fluid through the second fluid outlet,
wherein the first fluid passage and the second fluid passage interface such that the second fluid is entrained in the first fluid through a formation of a low-pressure region in the first fluid, and
wherein the first fluid passage is configured such that the first fluid passes through at least a portion of the first fluid passage in a form of a plurality of first fluid streams.

2. The fluid channel assembly of claim 1, wherein the first fluid passage is contained at least partially within the second fluid passage, or the first fluid passage is entirely contained within the second fluid passage.

3. The fluid channel assembly of claim 1, wherein the first fluid passage is configured such that the plurality of first fluid streams is formed by channeling the first fluid through a corresponding plurality of first nozzle structure apertures.

4. The fluid channel assembly of claim 3, wherein the plurality of first nozzle structure apertures is arranged along a single plane.

5. The fluid channel assembly of claim 3, wherein the plurality of first nozzle structure apertures is arranged along a two-dimensional matrix.

6. The fluid channel assembly of claim 3, wherein the plurality of first nozzle structure apertures is arranged in a form of folded plane configuration.

7. The fluid channel assembly of claim 3, wherein one of the plurality of first nozzle structure apertures is separated by another of the plurality of first nozzle structure apertures by a nozzle structure aperture gap.

8. A fluid channel assembly comprising:
a first fluid passage comprising a first fluid inlet and a first fluid outlet, wherein the first fluid passage is configured to receive a first fluid at the first fluid inlet, and wherein the first fluid passage is configured to channel the first fluid through the first fluid outlet, and
a second fluid passage comprising a second fluid inlet and a second fluid outlet, wherein the second fluid passage is configured to receive a second fluid at the second fluid inlet, and wherein the second fluid passage is configured to channel the second fluid through the second fluid outlet,
wherein the first fluid passage and the second fluid passage interface such that the second fluid is entrained in the first fluid through a formation of a low-pressure region in the first fluid, and
wherein, along a plane perpendicular to the second fluid outlet, a cross-sectional area of the second fluid passage is greater than or equal to 25 times a cross-sectional area of the first fluid passage.

9. The fluid channel assembly of claim 8, wherein the first fluid passage is contained at least partially within the second fluid passage, or the first fluid passage is contained entirely within the second fluid passage.

10. The fluid channel assembly of claim 8, wherein the first fluid passage comprises a plurality of first nozzle structure apertures and wherein the plurality of first nozzle structure apertures is arranged along a single plane.

11. The fluid channel assembly of claim 8, wherein the first fluid passage comprises a plurality of first nozzle structure apertures and wherein the plurality of first nozzle structure apertures is arranged along a two-dimensional matrix.

12. The fluid channel assembly of claim 8, wherein the first fluid passage comprises a plurality of first nozzle structure apertures and wherein the plurality of first nozzle structure apertures is arranged in a form of folded plane configuration.

13. A fluid channel assembly comprising:
a first fluid passage comprising a first fluid inlet and a first fluid outlet, wherein the first fluid passage is configured to receive a first fluid at the first fluid inlet, and wherein the first fluid passage is configured to channel the first fluid through the first fluid outlet, and
a second fluid passage comprising a second fluid inlet and a second fluid outlet, wherein the second fluid passage is configured to receive a second fluid at the second fluid inlet, and wherein the second fluid passage is configured to channel the second fluid through the second fluid outlet,
wherein the first fluid passage and the second fluid passage interface such that the second fluid is entrained in the first fluid through a formation of a low-pressure region in the first fluid, and
wherein the first fluid passage and the second fluid passage are arranged such that, under operational conditions, a ratio of a mass flow rate of the second fluid in the fluid channel assembly to a mass flow rate of a first fluid in the fluid channel assembly of greater than or equal to 25 is achieved.

14. The fluid channel assembly of claim 13, wherein the first fluid passage is configured such that a plurality of first fluid streams is channeled through the first fluid outlet to form of a plurality of first fluid streams.

15. The fluid channel assembly of claim 13, wherein the first fluid passage is contained at least partially within the second fluid passage. or the first fluid passage is entirely contained within the second fluid passage.

16. The fluid channel assembly of claim 13, wherein the first fluid passage comprises a plurality of first nozzle structure apertures and wherein the plurality of first nozzle structure apertures is arranged along a single plane.

17. The fluid channel assembly of claim 13, wherein the first fluid passage comprises a plurality of first nozzle structure apertures and wherein the plurality of first nozzle structure apertures is arranged along a two-dimensional matrix.

18. The fluid channel assembly of claim 13, wherein the first fluid passage comprises a plurality of first nozzle structure apertures and wherein the plurality of first nozzle structure apertures is arranged in a form of folded plane configuration.
